(19) United States
(12) Patent Application Publication
(10) Pub. No.: US 2004/0035624 A1
(43) Pub. Date: Feb. 26, 2004

(54) Components for a three-wheeled vehicle to permit leaning of the driver

(76) Inventors: Berthold Fecteau, Richmond (CA); Bruno Girouard, Montreal (CA); Alain Massicotte, Orford (CA); Martin Aube, St-Bruno-de-Montarville (CA)

Correspondence Address: PILLSBURY WINTHROP, LLP, P.O. BOX 10500, MCLEAN, VA, 22102, US

(21) Appl. No.: 10/371,230

(22) Filed: Feb. 24, 2003

Related U.S. Application Data
(60) Provisional application No. 60/358,362, filed on Feb. 22, 2002.
(60) Provisional application No. 60/358,400, filed on Feb. 22, 2002.

(51) Int. Cl. B62K 5/02

(52) U.S. Cl. 180/210

(57) ABSTRACT

A novel three-wheeled straddle type vehicle for operation by at least one rider is disclosed having components to permit leaning of the driver during operation. The vehicle includes a straddle type seat connected to the frame. The seat has recessed central portion that permits the driver to lean across the vehicle to ensure proper orientation of the driver on the vehicle for improved maneuverability and handling by the driver. The three wheeled vehicle in accordance with the present invention further includes a pair of toe holds connected to the frame for engaging a top portion of the driver's feet when the driver leans during operation of the vehicle.

### CROSS REFERENCE TO RELATED APPLICATIONS

This application is related to and claims priority to U.S. Provisional Patent Application Serial No. 60/358,362, which was filed on Feb. 22, 2002, and U.S. Provisional Patent Application Serial No. 60/358,400, which was filed on Feb. 22, 2002. The disclosures of these related applications are specifically incorporated herein by reference.

This application is also related but does not claim priority to the following U.S. provisional applications that were filed on Feb. 22, 2002: No. 60/358,394; No. 60/358,390; No. 60/358,395; No. 60/358,436; No. 60/358,397; No. 60/358,439; and, No. 60/358,398 and any non-provisional patent applications claiming priority to the same. This application is also related but does not claim priority to U.S. provisional application No. 60/358,737 filed on Feb. 25, 2002, and U.S. provisional application No. 60/418,355, which was filed on Oct. 16, 2002 and any non-provisional patent applications claiming priority to the same. The entirety of the subject matter of these applications is incorporated by reference herein.

This application is also related to but does not claim priority to U.S. Design Application No. 29/155,964 filed on Feb. 22, 2002, and U.S. Design Application No. 29/156,028 filed on Feb. 23, 2002. This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the Invention

The present invention relates to the overall design and construction of a novel three-wheeled vehicle designed for road use. Particularly, the present invention relates to a novel three-wheeled straddle-type vehicle having a tubular frame structure where the position of the center of gravity of the rider is improved in contrast to conventional three wheeled vehicles to permit the rider to lean on the vehicle during operation. The layout of the seat assembly and foot pegs is designed to facilitate leaning by the driver when turning to increase vehicle stability. The vehicle has improved maneuverability, handling and control over conventional three wheel vehicles.

2. Description of Related Art

There are numerous known vehicles powered by internal combustion engines, which are designed for road use and/or off road use. It has been found that handling and maneuverability of a vehicle is often altered and improved by a rider changing position during use. For example, a rider leaning to one side while traveling through a curve can improve the stability of the vehicle through the curve. Most vehicles, however, are not designed to permit the rider to vary his or her position when operating the vehicle.

One such vehicle is an all terrain vehicle (ATV) having two front wheels, two rear wheels and a saddle type seat. ATV's typically have a higher center of gravity compared to other vehicles. The rider is normally situated in a prone position during the operation of the ATV. The rider may shift his/her weight during operation of the ATV, but this weight shift is a result of a conscious effort by the rider. There is no structure, however, to assist the rider to return to a prone or upright position. In general, ATV's are not designed for a rider to lean during turning.

Attempts have been made to modify an ATV to produce a straddle-type three-wheeled vehicle with two front wheels and one rear wheel. For example, U.S. Pat. No. 4,787,470 discloses a three-wheeled vehicle with two front wheels and a sole rear wheel having a body formed by an ATV frame carrying two front and one rear fenders and a saddle type seat. The position of the rider, however, is not altered during operation. Like the ATV, the vehicle is not designed to facilitate rider leaning.

Another vehicle is a snowmobile, which is designed for trail use and off-trail use. The snowmobile has a straddle-type seat. Like the ATV, the driver of the snowmobile is in a prone position during operation of the snowmobile. Although the driver may in certain circumstances lean to one side or another of the snowmobile, the driver typically remains in a prone position. Furthermore, the seat is not designed to facilitate leaning. Nor is there a structure to facilitate leaning while permitting the easy return to a prone or upright position.

Attempts have also been made to modify a snowmobile to produce a straddle-type three-wheeled vehicle. U.S. Pat. No. 4,662,468 also discloses a three-wheeled vehicle with two front wheels and a sole rear wheel. The three-wheeled vehicle of the '468 patent uses a conventional snowmobile chassis, which has been modified to attach two driving wheels at its front portion.

U.S. Pat. No. 5,564,517 discloses a snowmobile conversion frame kit which includes a frame having two wheels with a steering assembly in the front and a single wheel with a swing arm in the rear. The kit in the '517 patent is designed to be secured to a conventional snowmobile chassis also. Conventional snowmobile chasses offer less rigidity and structural strength than are required for the all-terrain vehicles. Both of these vehicles suffer from the above-described drawbacks, namely these three wheeled vehicles are not designed to facilitate leaning during operation. As such, these vehicle have reduced stability when turning at higher speeds.

Another known vehicle is the motorcycle having one front wheel and one or more rear wheels. The motorcycle is a self leaning vehicle. It is necessary for the driver to lean when turning in order to maintain the vehicle in an upright position. Both the driver and the motorcycle lean when turning. Three wheel vehicles, however, are not self leaning. The provision of the third wheel prevents this.

### OBJECTS OF THE INVENTION

It is an object of the present invention to provide a three-wheeled straddle type vehicle having two wheels in the front of the vehicle and one wheel in the rear of the vehicle.

It is another object of the present invention to provide a three-wheeled straddle type vehicle having a low center of gravity compared to conventional three wheeled vehicles.

It is another object of the present invention to provide a three-wheeled straddle type vehicle having improved maneuverability and control by comparison with conventional three wheeled vehicles.

It is another object of the present invention to provide a three-wheeled straddle type vehicle designed for road use.

It is another object of the present invention to provide a three-wheeled straddle type vehicle having a tubular frame with improved strength.

It is another object of the present invention to provide a three-wheeled straddle type vehicle having a seat assembly that is designed to facilitate rider leaning when turning.

It is another object of the present invention to provide a three-wheeled straddle type vehicle having a pair of toe holds connected to the tubular frame of the vehicle, whereby the driver's feet engage at least one of the toe holds when the driver leans towards a side of the vehicle when driving for example through a curve in the road.

It is another object of the present invention to provide a three-wheeled straddle type vehicle having a seat with a recessed portion that is sized to receive a portion of one of the driver's legs when the driver leans towards a side of the vehicle when driving for example through a curve in the road.

It is another object of the present invention to provide a three-wheeled straddle type vehicle having knee leaning pad assembly located on opposite sides of the vehicle to assist the rider when leaning to one side of the vehicle and to minimize rider contact with the frame.

### SUMMARY OF THE INVENTION

In response to the foregoing challenges, applicants have developed a novel three-wheeled vehicle that offers improved maneuverability and control. In particular, the present invention relates to a three-wheeled straddle-type vehicle having two wheels in the front of the vehicle and one wheel in the rear of the vehicle. By utilizing a vehicle having, inter alia, a frame structure with an upper support assembly, the present invention provides a high performance three-wheeled vehicle with excellent maneuverability and control.

An aspect of the present invention is that the three-wheeled vehicle is essentially an adaptation of a snowmobile body and frame. A principle benefit of the adapting a snowmobile to the vehicle of the present invention is that the vehicle maintains many of the beneficial structural attributes of a snowmobile, such as its low center of gravity. Further, the closer proximity of the center of gravity of the rider in operation to the low center of gravity of the vehicle plays a factor in providing a much more stable three-wheeled vehicle than three-wheeled vehicles heretofore available, which were adapted from all-terrain vehicle or motorcycle frames.

Both the '468 and '517 patent lack the upper support structure which is part of the present invention. Further, the three-wheeled vehicles disclosed in the '468 and '517 patents are based on conventional snowmobile chassis configuration. Accordingly, they necessarily lack the benefits of the new driver positioning and the relationship between the steering control position, the seating position, and the position of the footrests, which permit an improved maneuverability and control of the vehicle, especially a wheeled vehicle intended for road use.

A notable aspect of the three-wheeled vehicle of the present invention is that it is designed to operate with an engine capable of generating 80-135 horsepower or even greater and that it is intended for road use. Many of the three-wheeled vehicles heretofore available have been mostly capable of 30 horsepower (hp), and especially less than 100 hp, due to limitations in the structural strength of the frame and the maneuverability and stability of the vehicle. The novel frame assembly of the three-wheeled vehicle of the present invention provides sufficient structural rigidity to withstand the forces experienced during high performance operation of the vehicle. Further, with the improved positioning of the center of gravity of the rider vis-à-vis the center of vehicle, the present invention alleviates the problems of instability and lack of control in sharp turns or during abrupt directional changes.

Another notable aspect of the three-wheeled vehicle is that it is designed for road use, like a motorcycle. Off-road use is also contemplated, but it is not the primary focus of the design.

Applicants have developed a novel a three-wheeled straddle type vehicle for operation by at least one rider. The vehicle includes a frame having a front portion and a rear portion. A pair of front wheels is rotatably connected to the front portion of the frame. A single rear wheel is rotatably connected to the rear portion of the frame. Each wheel may include one or more tires mounted thereon. The vehicle includes an engine connected to the frame. The engine provides power to drive at least one of the single rear wheel and the pair of front wheels.

The vehicle includes a straddle type seat connected to the frame. The seat is positioned on the frame such that the rider of the vehicle straddles the seat when operating the vehicle. In accordance with the present invention, the straddle type seat has a side profile and a top profile. The side profile includes a central portion having a first height, a front end portion having a second height and a rear end portion having a third height. The first height of the central portion is less than each of the second height and the third height to create a seat assembly having a central dip. This seat configuration ensures proper orientation of the driver on the vehicle for improved maneuverability and handling.

The vehicle further includes a pair of foot rests connected to the frame. A first foot rest is located on one side of the seat such that a portion of one foot of the driver rests on the first foot rest during operation of the vehicle. A second foot rest is provided on an opposite side of the seat such that a portion of another foot of the driver rests on the second foot rest during operation of the vehicle. A central area of the straddle seat is substantially aligned with the pair of foot rests.

The three wheeled vehicle in accordance with the present invention further includes a first toe hold connected to the frame located on one side of the seat. The first toe hold is spaced from the first foot rest. The top portion of a foot of the driver engages the first toe hold when the driver leans to the other side of the vehicle during operation of the vehicle. A second toe hold is connected to the frame located on the opposite side of the seat. The second toe hold is spaced from the second foot rest. During operation of the vehicle, the top portion of the other foot of the driver engages the second toe hold when the driver leans to the opposite side of the vehicle. It is contemplated that the first and second toe holds may include a peg secured to the frame of the vehicle. Alternatively, it is contemplated that the toe holds may be formed as foot guards that partially surrounds the feet of the driver.

The top profile of the straddle type seat includes a central straddle portion having a first width, a front portion having a second width and a rear portion having a third width. The central straddle portion does not necessarily correspond to the exact center of the seat. The first width is less than each of the second width and the third width. The central straddle portion is sized to receive a portion of a leg of the rider when the rider leans to one side of the vehicle. The central straddle portion is substantially aligned with the pair of foot rests, the first toe hold and the second toe hold.

### BRIEF DESCRIPTION OF THE DRAWINGS

The invention will be described in conjunction with the following drawings in which like reference numerals designate like elements and wherein:

FIG. 1 is a front view of the three-wheeled straddle-type vehicle in accordance with an embodiment of the present invention;

FIG. 2 is a right side view of the three-wheeled straddle-type vehicle of FIG. 1;

FIG. 3 is a top view of the three-wheeled straddle-type vehicle of FIG. 1;

FIG. 4 is a front left perspective view of the frame assembly for the three-wheeled straddle-type vehicle;

FIG. 5 is a left side view of the frame assembly of FIG. 4;

FIG. 6 is a partial schematic side view of the vehicle in accordance with the present invention illustrating the location of the toe holds, foot pegs and the straddle type seat;

FIG. 7 is a partial left rear schematic side view of the vehicle illustrating the location of the toe holds, foot pegs and the straddle type seat;

FIG. 8 is a schematic view of the handle bars in accordance with an embodiment of the present invention;

FIG. 9 is a schematic view of the handle bars in accordance with another embodiment of the present invention;

FIG. 10 is a side view of a conventional motorcycle that has been converted into a three-wheel vehicle; and

FIG. 11 is a partial side view of the conventional three-wheel vehicle of FIG. 18.

FIG. 12 is a left front schematic view of the frame of the three-wheeled straddle-type vehicle having foot boards secured thereto in accordance with another embodiment of the present invention;

FIG. 13 is a partial left rear schematic view of the foot boards of FIG. 12; and

FIG. 14 is a partial left front schematic view of the foot boards of FIG. 12.

### DETAILED DESCRIPTION OF PREFERRED EMBODIMENTS

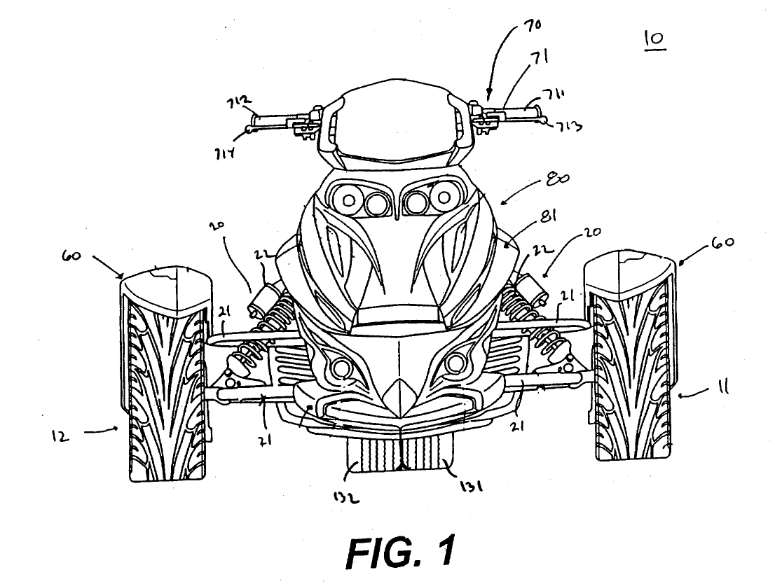

A three-wheeled straddle type vehicle 1 in accordance with the present invention is generally illustrated in FIGS. 1-3. The vehicle 1 is designed with a straddle-type seat assembly 90 that preferably accommodates two adult-sized riders, a driver and a passenger. While the vehicle 1 is not designed to accommodate more than two adult-sized riders, the present invention contemplates that the design of vehicle 1 may be changed easily to accommodate more than two adult-sized riders. It should be noted that the conventions “left,” “right,” “front,” “rear,” “up,” and “down” are defined according to the normal, forward travel direction of the vehicle being discussed. As a result, the “left” side of a vehicle corresponds to the left side of a rider seated in a forward-facing position on the vehicle.

The vehicle 1 includes a left front wheel 11, a right front wheel 12 and a rear wheel 13. In accordance with the present invention, each wheel may include one or more rims. Each rim accommodates a tire thereon. When multiple rims are provided for a single wheel, a rigid connection exists there between such that the rims and the tires rotate as a single unit. The left and right front wheels 11 and 12 have tires secured thereto, respectively. The rear wheel 13 has one or more tires 131 and 132 secure thereto. The tires 131 and 132 rotate together. Each of the wheels 11, 12 and 13 is sized to accommodate at least one 15-inch automotive tire. The present invention, however, is not limited to equal sized wheels; rather, it is contemplated that the front wheels 11 and 12 may be smaller in size to accommodate a 13-inch automotive tire. Furthermore, other wheel sizes are considered to be well within the scope of the present invention.

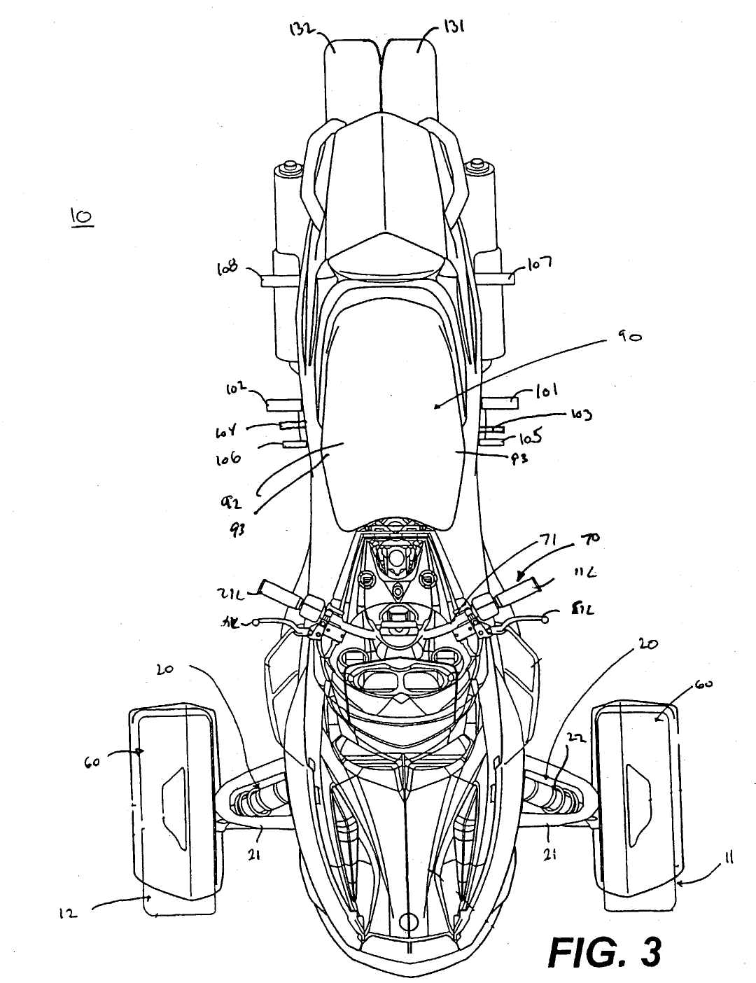

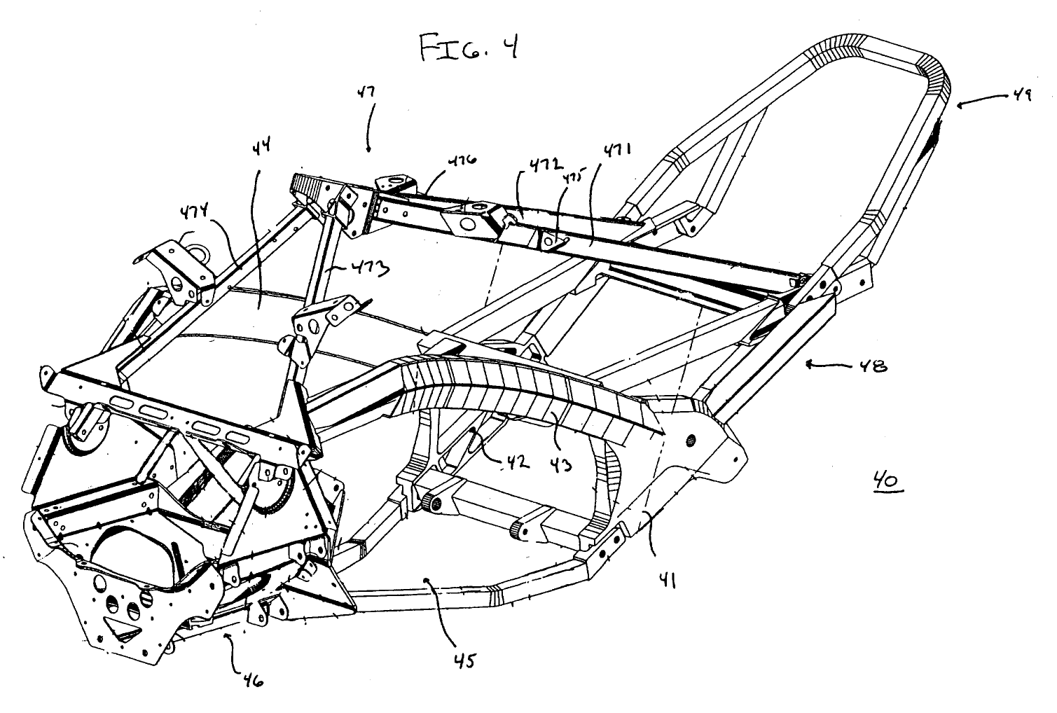

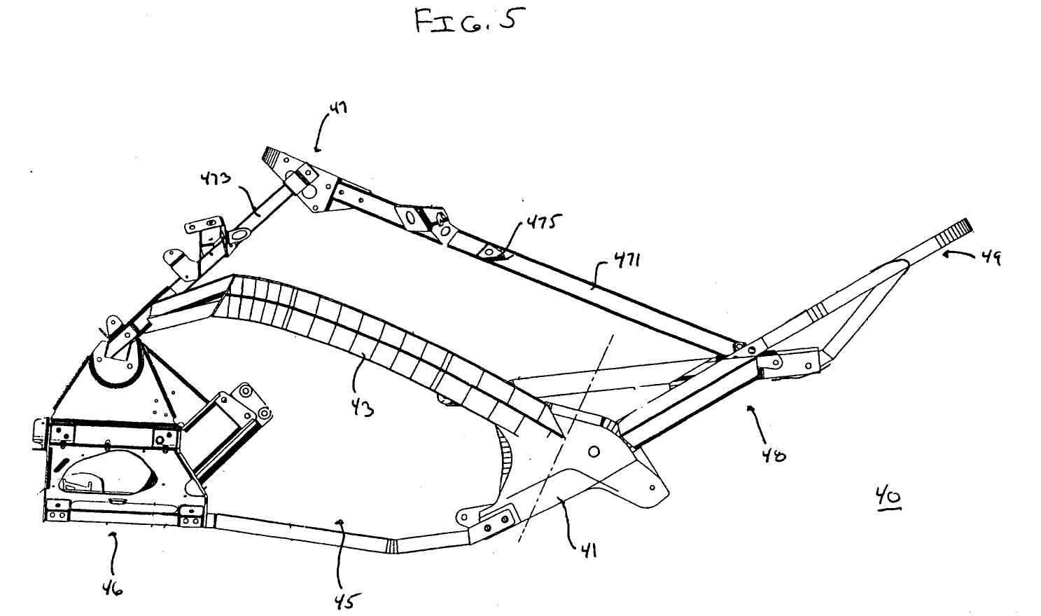

The front wheels 11 and 12 are supported by a front suspension assembly 20. The rear wheel 13 is supported by a rear suspension assembly 30. The front suspension assembly 20 and the rear suspension assembly 30 are secured to a vehicle frame assembly 40, illustrated in FIGS. 4-6. As shown in FIGS. 1 and 3, the front suspension assembly 20 includes a pair of suspension support arms (A-arms) 21 and a shock absorber 22 extending from each side of the frame assembly 40 to support the wheels 11 and 12.

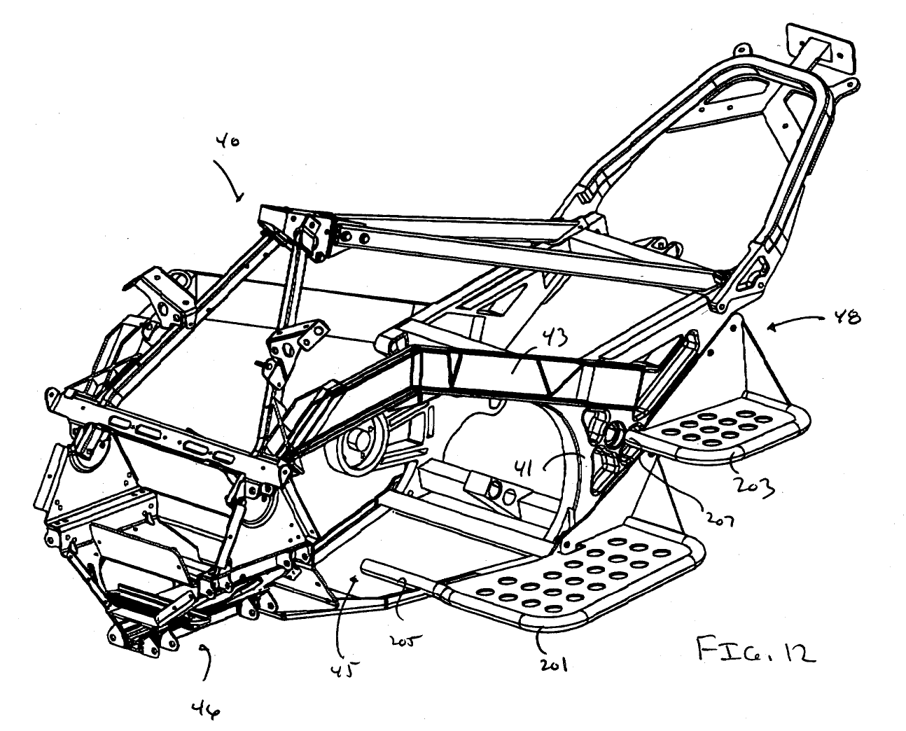

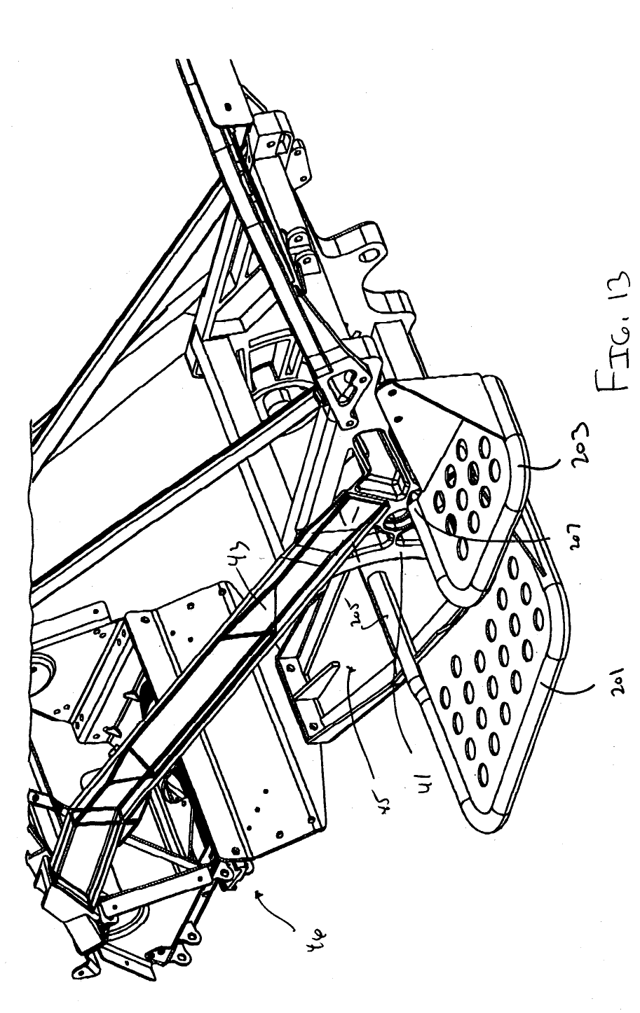

The frame assembly 40 includes left and right laterally-spaced rear suspension plates 41 and 42. The swing arm of the rear suspension 30 is pivotally secured to the plates 41 and 42. Left and right upper spars 43 and 44 extend upwardly and forwardly from upper portions of the left and right rear suspension plates 41 and 42. It is contemplated that the plate 41 and left spar 43 can be integrally formed or cast, as shown in FIGS. 12-14. The plate 42 and right spar 44 can be integrally formed or cast. An engine cradle 45 extends forwardly from the lower forward portions of the plates 41 and 42. A front suspension sub-frame 46 is secured to the engine cradle 45 and the upper spars 43 and 44. The front suspension 20 is secured to the front suspension sub-frame 46.

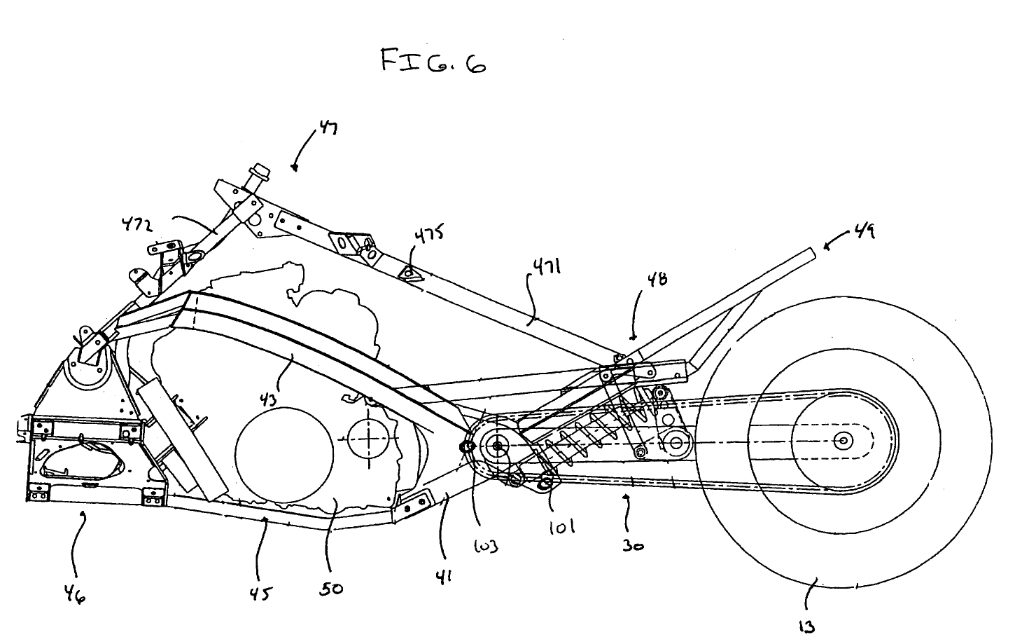

An engine 50 is secured to the vehicle frame assembly 40 through the engine cradle assembly 45, and may be secured directly to the frame assembly 40 at several points of attachment, as illustrated in FIG. 6. The engine 50 is supported just behind the front assembly 20 just above the bottom of the frame assembly 40. This positioning provides a lower center of gravity, which is useful for ensuring good handling and stability of the vehicle 10. Because of the rigidity and improved structural strength of the frame assembly 40, the engine 50 can generate 80-135 horsepower or more without compromising the operation of the vehicle 1. The frame assembly 40 provides sufficient structural rigidity to withstand the forces created during high performance operation of the vehicle 10. In dramatic contrast, conventional three-wheeled vehicles have incorporated engines that generate only 30 horsepower (or less) due to limitations in the structural strength of their frames and maneuverability and stability of their construction. The frame assembly 40 is preferably a tubular frame, with at least some of the frame elements being formed of tubular members. The tubular members can have any cross section, including but not limited to square, rectangular, circular, oval and channel shaped. As such, tubular members contemplated by this invention include both closed and open cross sections, which may be made by casting, forging, stamping, or extrusion. The advantage of tubular members is that such elements are very strong, yet lightweight.

The engine 50 may be an internal combustion engine. Preferably, the engine 50 is a four-stroke engine. Specifically, the engine 50 may be a 1000 cc four-stroke V-twin (V2) engine manufactured by ROTAX®. The vehicle 1 in accordance with the present invention, however, is not limited to a 1000 cc engine. It is contemplated that a 600 cc two-stroke engine may also be used. Furthermore, other engine displacement sizes are considered to be well within the scope of the present invention. Moreover, while a four-stroke engine is contemplated for use on the vehicle 10, a two-stroke engine also may be employed. It is contemplated that the engine 50 may have a continuously variable transmission (CVT) or a manual transmission,

As illustrated in FIGS. 4-7, the frame 40 further includes an upper support assembly 47. The upper support assembly 47 includes left and right upper column rear members 471 and 472. The rear members 471 and 472 are connected to the rear suspension sub-frame 48. The upper support assembly 47 further includes left and right upper column front members 473 and 474. The front members 473 and 474 are connected to the front suspension sub-frame 46. The frame 40 further includes a rear sub-frame 49. As will be described in greater detail below, a seat assembly 90 is secured to the upper support assembly 47 at left and right seat anchors 475 and 476. The seat assembly 90 rests on the rear members 471 and 472 and the rear sub-frame 49.

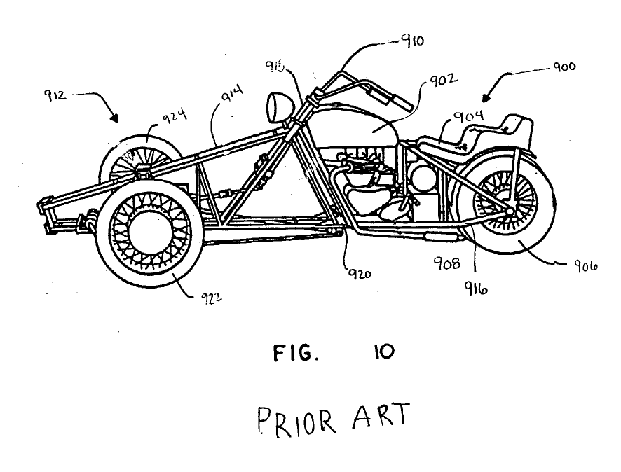

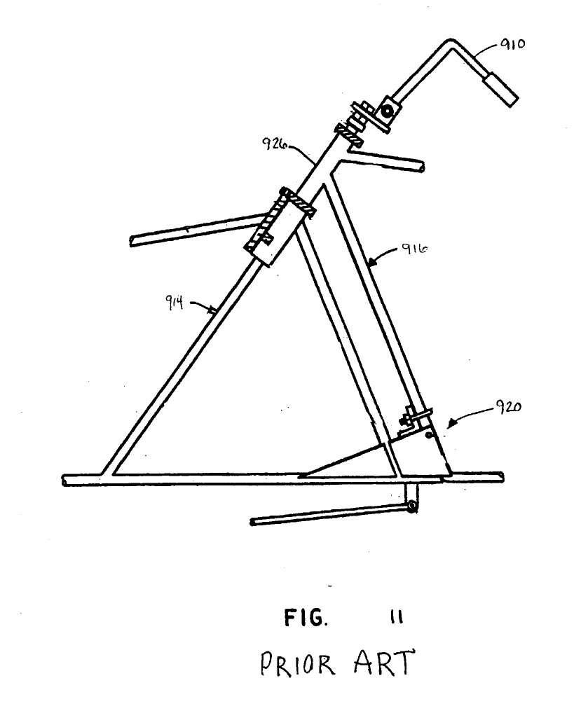

The frame assembly 40 is discussed in greater detail in copending U.S. Provisional Patent Application Serial No. 60/358,390 and copending U.S. patent application Ser. No. ______(RP-01202-US2), the disclosures of which are incorporated specifically herein by reference. It is contemplated that the frame may include both tubular components and cast components. The frame assembly 40 of the present invention may be distinguished from a motorcycle converted into a three-wheeled vehicle for at least one additional reason. FIGS. 10 and 11, which are reproduced from U.S. Pat. No. 5,326,060 are exemplary.

FIG. 10 illustrates a conventional motorcycle 900 with a fuel tank 902, seat 904, rear tire 906, engine 908, and handlebars 910. In FIG. 10, the front tire of the motorcycle 900 has been removed and replaced by a conversion kit 912.

The conversion kit 912 includes a box frame 914 made up of two tubular members in the shapes of triangles connected together via cross-members. The conversion kit 912 attaches to the frame 916 of the motorcycle 900 at the head 918 of the motorcycle 900 and also at a lower portion 920 of the frame 916. As illustrated the frame 914 of the conversion kit 912 has two tires 922, 924 suspended therefrom.

While the conversion kit 912 attaches to the frame 916 at a lower portion 920, importantly, the frame 914 also connects to the frame 916 through the head 918 of the motorcycle 900. The head 918 includes, among other components, a head pipe 926, illustrated in FIG. 11. The head pipe 926 is the cylindrical fitting, usually welded to the frame 916, through which the steering shaft of the handlebars 916 pass to steer the front wheel of the motorcycle 900. The head pipe 926, therefore, is a component of the motorcycle frame 916 that bears the weight of the motorcycle 900 and the rider. In other words, the head pipe 926 acts as a force focal point of the motorcycle frame 916 by bearing the weight of a portion of the motorcycle 900 and the rider. In addition, the head pipe 926 is the point through which the braking force of the motorcycle 900 is channeled. When the front brakes are applied, a portion of the weight of the motorcycle 900, a portion of the weight of the rider, and a portion of the decelerating force on the motorcycle 900 are all channeled through the head pipe 926 to the front tires 922, 924.

One way in which the frame assembly 40 of the present invention differs from the frame 916 and conversion kit 912 of the prior art is in the fact that the frame assembly 40 is not a kit 912 designed to modify a motorcycle 900 to include two front wheels 922, 924. One way to define the frame assembly 40 is to examine the basic elements that distinguish the frame assembly 40 from the frame conversion kit 912.

The frame assembly 40 differs from the conversion kit 912 by the simple fact that the frame assembly 40 is not a conversion kit. The frame assembly 40 is an entirely new frame specifically designed to withstand the forces encountered by a three-wheeled vehicle during high-performance road operation.

The frame assembly 40 also differs from the frame conversion kit 912 by the fact that the frame assembly 40 does not include a head pipe 926 or any other structure through which weight or braking forces are channeled to any other portion of the frame assembly 40. The mere fact that the frame assembly 40 does not rely on the head pipe 926 as a force focal point distinguishes the frame assembly 40 from the prior art. In addition, the fact that the frame assembly 40 does not relay on a head pipe 926 and a force focal point means that the forces acting on and generated by the vehicle 1 are more evenly distributed over the various frame components. As a result, handling characteristics for the vehicle 1 are greatly enhanced. For ease of reference, the frame assembly 40 will also be referred to as a head pipeless frame or as a frame lacking a force focal point.

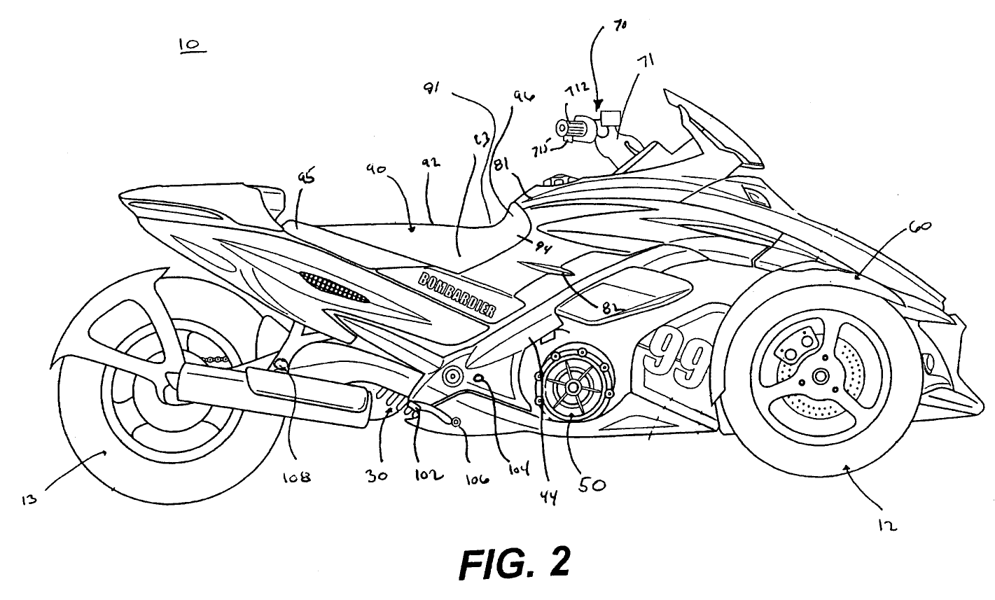

As illustrated in FIGS. 1-3, a fender assembly 60 is associated with each of the front wheels 11 and 12. As shown in FIGS. 1 and 2, each fender assembly 60 covers the top rear portion of the tires. The fender assembly 60 prevents dirt, water and road debris from being kicked up onto the rider, while the rider operates the vehicle 1. Each fender assembly 60 is linked to the front suspension assembly 20 and a steering assembly 70 such that it moves in connection with the wheels 11 and 12 during steering of the vehicle 1.

The steering of the front wheels 11 and 12 is accomplished through the use of the steering assembly 70. The steering assembly 70 includes handlebars 71 and steering linkages (not shown) connected to the wheels 11 and 12 for purposes of turning the wheels 11 and 12 in response to movement of the handlebars 71. The steering assembly 70 of the vehicle 1 is preferably provided with a progressive steering system (not shown). The progressive steering system allows the handlebars 71 to be turned to their maximum position (about 50 degrees of arc), while the wheels 11 and 12 turn to an increasingly greater extent. The linkage between the handle bars 71 and the steering linkages (not shown) that makes progressive steering possible is designed so that small variations in the handlebars 71 when the vehicle is travelling straight will not turn the wheels to any significant degree. In other words, when the vehicle 10 is travelling forward, especially at high speed, there should be a good amount of play in the handlebars 71 so that small movements made by the driver do not result in a sudden (or unexpected) turning of the vehicle 1. On the other hand, when the handlebars 71 are turned to a more significant displacement, the degree of play preferably should decrease as the angular displacement of the handlebars 71 increases. In other words, the closer the handlebars 71 are turned to their most rotated position, the less play there should be in the linkage between the handlebars 71 and the wheels 11 and 12 of the vehicle 1.

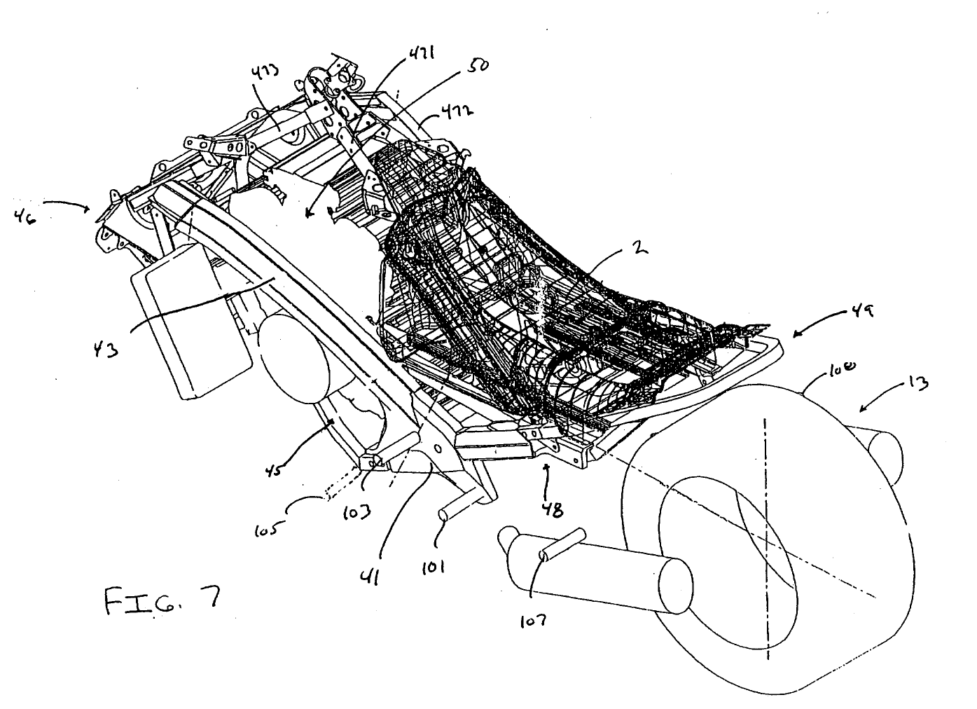

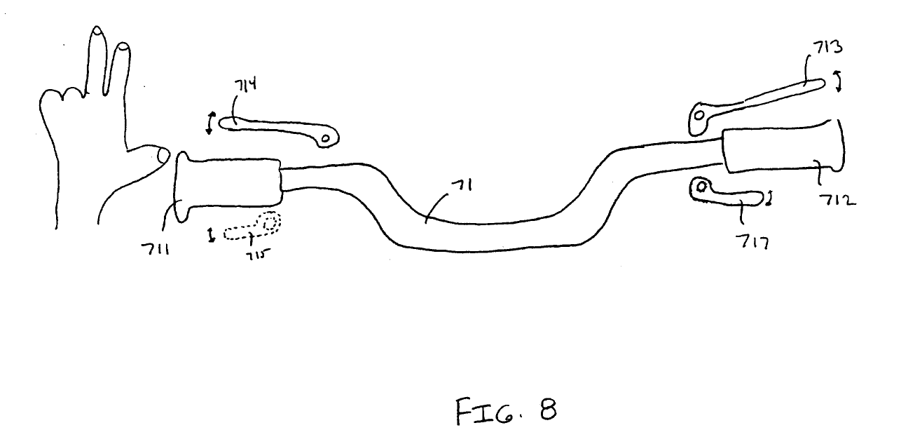

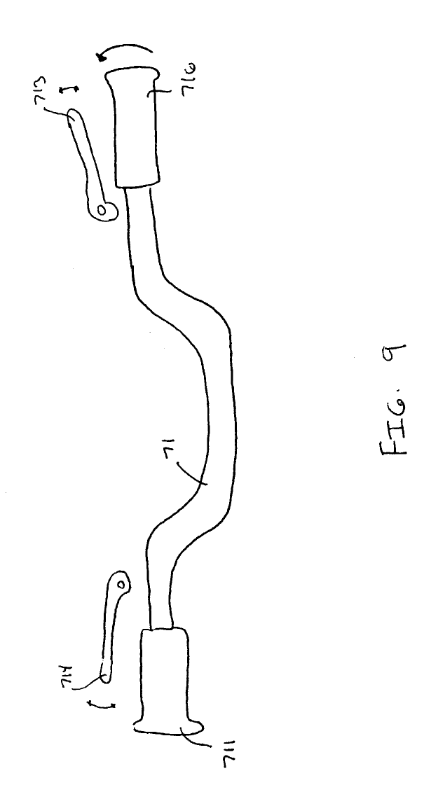

An embodiment of the handlebars 71 is illustrated in FIG. 7. The handlebars 71 include left and right hand grips 711 and 712, respectively. A pivoted braking lever 713 is located adjacent the right hand grip 712. The braking lever 713 is adapted to be gripped by fingers of the right hand to operate the braking system of the vehicle 1. The braking lever 713 operates the brakes for both the front wheels 11 and 12 and the rear wheel 13. The provision of the hand brake 713 for braking both the front wheels and the rear wheel assists in leaning because it is no longer necessary for the driver to have his or her foot on the braking foot pedal, as described below. When a manual transmission is provided, a clutch is necessary. A pivoted clutch lever 714 is located adjacent the left hand grip 712. In a preferred form, the clutch lever 714 has a shorter length than the braking lever 713 such that the lever 714 is not engaged by all of the fingers of the driver's left hand. Instead, the operation of the lever 714 is controlled by using one or two fingers. It, however, is contemplated that the length of the lever 714 may be the same as the length of the lever 713. It is also contemplated that the lever 714 may be replaced by a thumb clutch lever 715. The right hand grip 712 is also provided with a thumb throttle lever 717, as shown in FIG. 8. Still further, it is contemplated that the lever 717 may be replaced by a rotatable throttle 716 at the right hand grip much like a throttle in motorcycle, as shown in FIG. 9. The throttle may also be finger activated. When a CVT is provided, a clutch is no longer necessary. As such, the clutch levers 714 or 715 can be omitted. Alternatively, the lever 714 can also control braking. The lever 714 may be used to control both front and rear braking.

As shown in FIG. 1, the front of the vehicle 1 includes a fairing assembly 80, which encloses the engine 50 to protect it and to provide an external shell that can be decorated so that the vehicle 1 is aesthetically pleasing. The fairing assembly 80 extends along the sides of vehicle 1. The side portions of the fairing assembly 80 include a leaning pad 82. The leaning pad 82 is positioned ahead of the seat assembly 90 in the vicinity of the rider's knees. The leaning pads 82 provide a smooth transition to the upper spars 43 and 44, which minimizes driver impact with the spars 43 and 44 when leaning. The pads 82 also assist to facilitate leaning. When the driver wants to lean to a particular side of the vehicle 1, the driver simply applies pressure to one of the leaning pads 82, which permits the driver to shift positions on a seat assembly 90.

The upper portion 81 of the fairing assembly 80 extends to a cushioned rider seat assembly 90 that is mounted to the frame assembly 40 between the front wheels 11 and 12 and the rear wheel 13, as shown in FIGS. 1-3. The cushioned seat assembly 90 is mounted to the seat anchors 475 and 476 and rests on the rear supports 471 and 472 and the U-shaped seat frame 49. The seat assembly 90 is positioned so that a weight of the rider thereon will be disposed generally above the rear cross brace 481 of the sub-frame 48, which supports the rear suspension links. Consequently, the weight of the rider will be transferred through the seat assembly 90 and frame assembly 40 to the rear cross brace 481, and from the rear cross brace 481 to the rear suspension assembly 30 and to the front suspension sub-frame 46 and front suspension assembly 20 through the front supports 473 and 474.

The seat assembly 90 will now be described in greater detail. The seat assembly 90 also has inwardly tapered side surfaces 93, as shown in FIGS. 2 and 3, near the dip 91 so that the rider can securely clamp their lower legs on either side of dip 91. A pair of side wings 94 extend forwardly from dip 91 and inwardly tapered sections 93. The side wings 94 are padded and form a clamping area for a rider's knees when a rider is shifted forward. As shown in FIG. 2, the leaning pads 82 on the fairing assembly 80 are positioned on the sides of the fairing assembly 80 near the side wings 94. The seat assembly 90 is formed of materials known for seating use on various types of vehicles including all terrain vehicles, motorcycles and snowmobiles. Preferably, the seat assembly 90 is formed of a molded plastic contoured shell with a resilient, foam inner support member supported by the shell and a durable all weather outer surface covering, such as vinyl, formed over the resilient member.

As seen in FIGS. 2 and 3, the contour of seat assembly 90 provides for central dip 91 portion that slopes gradually up to a raised portion 95 at the rear of the vehicle 1. The rear end of seat assembly 90 is preferably higher than dip 91. Also, the rear end of the seat assembly is preferably wider than the tapered side surfaces 93. The front end of the seat assembly 90 is also preferably a raised portion 96 that is higher with respect to a horizontal support surface than dip 91. As shown in FIG. 2, the front raised portion 96 is higher than rear raised portion 95. Front raised portion forms a cushioned area that protects the rider from impact with the gas tank 2 or steering assembly 70, along with the cushioned side wings 94 that allow a rider to bear against the sides of vehicle 1 to facilitate leaning.

Front raised portion 96 is shown as an integral portion of seat 90. However, if desired, front raised portion 96 could be a separate cushioned component. Similarly, side wings 94 are shown as integral extensions of seat assembly 90, but could be formed as separate cushioned or padded components. The relative vertical heights of the seat portions could also vary. For example, rear end of the seat 90 could be level or tapered at the back so that the rear end is level with the dip portion. The relative taper can also vary, but it is desired that the tapered section be sufficiently narrow to allow a rider to sit comfortably and securely with the lower legs and knees straddling the vehicle 1. The dip 91 coincides with a tapered side sections 93. The dip 91 and the tapered sections 93 are designed to support a rider at the knee and lower thigh with the feet being supported on the foot pegs 101 and 102, are described in greater detail below. By this positioning, a rider is able to lean or slide sideways while riding to facilitate maneuvering the vehicle 10 when the rider's knee is positioned slightly above the seat over dip 91. The rider can facilitate leaning by applying pressure to one of the leaning pads 82, which permits the rider to slide in a sideways direction on the seat 90.

It is also contemplated that the seat assembly 90 may be provided with only tapered sections 93, with no dip such that the side profile of the seat would be flat. Such a configuration would allow a rider to still clamp the sides of the seat while riding.

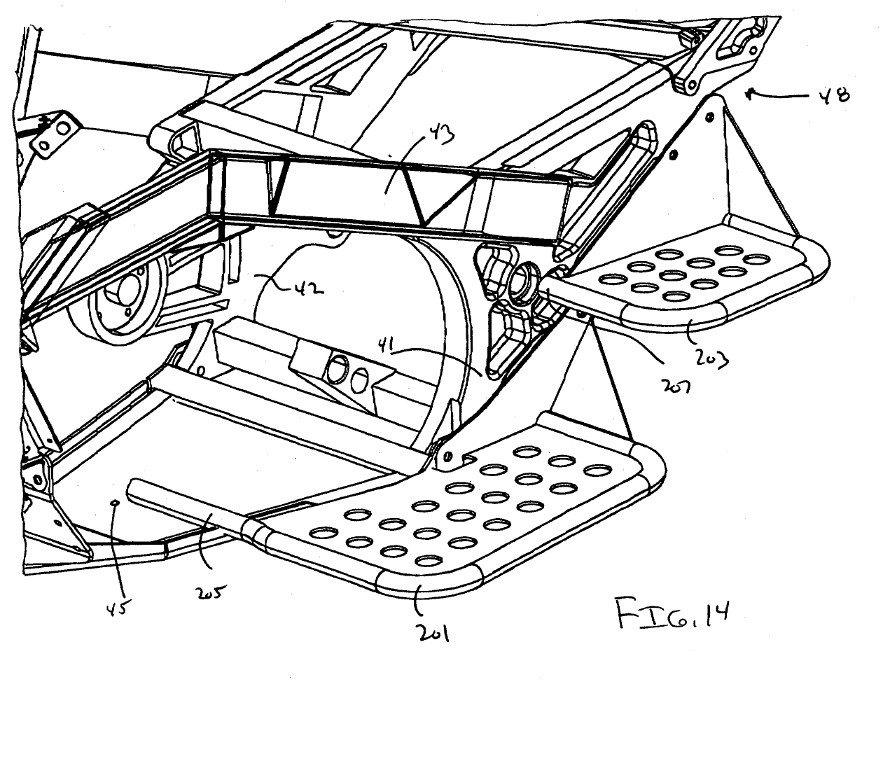

During operation, the driver is supported on the seat assembly 90. The driver's feet are supported on foot rests located on opposite sides of the frame 40. In one embodiment, driver's feet are supported by a left foot peg 101 and a right foot peg 102 located on opposite sides of the vehicle 1. The foot pegs 101 and 102 are secured to the anchor brackets 41 and 42, respectively. As illustrated, for example, in FIGS. 6 and 7, the left foot peg 101 is connected to the lower end of the anchor bracket 41. The right foot peg 102 is similarly connected to the lower end of the anchor bracket 42. The feet of the driver are supported on the foot pegs 101 and 102 during operation of the vehicle 1. The foot pegs 101 and 102 are designed to contact the lower surface of the driver's feet. It is also contemplated that the driver's fee may be supported by a pair of foot boards. In another embodiment, a left foot board 201 is illustrated in FIGS. 12-14. The left foot board 201 is secured to the anchor bracket 41 and the lower portion of the frame 40 adjacent the anchor bracket 41, as shown in FIGS. 12 and 14. A right foot board (not shown) is secured to the anchor bracket 42 in substantially the same manner as the left foot board 201. The left foot board 201 has an extension 205 that extends through the frame, as shown in FIGS. 12-14. The extension may be connected to a similar extension of the right foot board.

The vehicle 1 further includes a left toe hold 103 and a right toe hold 104 that are located on opposite sides of the vehicle 1. Like the foot pegs 101 and 102 and foot boards, the toe holds 103 and 104 are secured to the anchor brackets 41 and 42, respectively. As shown in FIG. 7, the left toe hold 103 is vertically and horizontally spaced from the left foot peg 101 or foot board 201. The right toe hold 104 is similarly spaced with respect to the foot peg 102 or right foot board. The toe holds 103 and 104 are designed to contact the upper surface of the driver's feet, when the driver leans to one of the sides of the vehicle 1 during operation (e.g., while leaning into a turn). When the driver leans to the right, the driver's left foot contacts the toe hold 103. When the driver desires to return to an upright position (e.g., at the completion of a right turn), the driver applies pressure in an upwardly direction against the left toe hold 103, which allows the driver to slide sideways across the seat 90 in an opposite direction so that the driver is once again centrally positioned on the seat. Similarly, when the driver leans to the left, the driver's right foot contacts the toe hold 104. When the driver desires to return to an upright position (e.g., at the completion of a left turn), the driver applies pressure in an upwardly direction against the right toe hold 104, which allows the driver to slide sideways across the seat 90 in an opposite direction so that the driver is once again centrally positioned on the seat. The toe holds 103 and 104 are illustrated as pegs that extend from the vehicle frame 40. The present invention, however, is not limited to the use of pegs; rather, it is contemplated that the toe holds 103 and 104 may take the form of a foot guard that partially surrounds the upper surface of the driver's foot.

The toe holds 103 and 104 are generally vertically spaced from a left foot pedal 105 and a right foot pedal 106, respectively. The right foot pedal 106 is used to control braking. The foot pedal may be used to control the braking of both the front and rear wheels. It is preferable that the foot pedal 106 control the braking of the rear wheel. The right hand lever 713 controls the braking of both the front wheels and the rear wheel. When a manual transmission is provided, the left foot pedal 105 may be the clutching mechanism to permit gear shifting. When a CVT is provided, the left foot pedal 105 is omitted.

As previously mentioned, the vehicle 1 is designed to accommodate more than one rider. It is contemplated that the vehicle 1 may be used by a driver and a rider, seated behind the driver. During operation, the rider is also supported on the seat assembly 90. The rider's feet are supported on foot rests located on opposite sides of the frame 40. In one embodiment shown in FIGS. 6 and 7, the rider's feet are supported by a left rear foot peg 107 and a right rear foot peg 108 located on opposite sides of the vehicle 1. The foot pegs 107 and 108 are secured to the sub-frame 48 of the vehicle 1. As illustrated, for example, in FIGS. 3 and 7, the left foot peg 101 is spaced from the left rear foot peg 107. The right foot peg 102 is similarly spaced from the right rear foot peg 108. The feet of the rider are supported on the foot pegs 107 and 108 during operation of the vehicle 1. In another embodiment, the rider's foot rests may be supported by a pair of foot boards. In the embodiment shown in FIGS. 12-14, a left foot board 203 is secured to the sub-frame 48. A right foot board (not shown) has the same construction as the left foot board 203 and is secured in the same manner. Like the foot board 201, the foot board 203 includes an exterior 207 that is connected to a similar extension of the corresponding right foot board. The extension 207 extends through the sub-frame 48, as shown in FIGS. 12-14.

It is contemplated that the vehicle 1 may include rear toe holds that are located on opposite sides of the vehicle 1. The rear toe holds are designed to contact the upper surface of the rider's feet, when the rider leans to one of the sides of the vehicle 1 during operation (e.g., while leaning into a turn). It is also contemplated that the foot pegs 101, 102, 107 and 108 may be replaced with a pair of foot platforms that extend along the opposite sides of the vehicle 1, as shown in FIGS. 12-14. The platforms are positioned such that are located below the foot pedals 105 and 106 so as not to interfere with the operation of the vehicle 1.

During operation, the driver straddles the seat assembly 90 such that the driver's legs are located adjacent the tapered side surfaces 93 of the seat assembly 90. The driver's feet are positioned on the foot pegs 101 and 102 or the foot boards. The driver's hands grip the handlebars 71. The handlebars 71 include controls for controlling the engine throttle and braking. With this arrangement, one hand controls the operation of the engine throttle. The other hand control performs at least part of the braking operation of the vehicle 1. The shifting between engine gears is controlled by operation of one of the foot pedals 105 and 106. The shifting is accomplished by either pressing down on the pedal or applying an upward force on the pedal to shift upward or downward. The braking of the vehicle 1 is also controlled by operation of the other of the foot pedals 105 and 106. The control may be similar to (or the same as) that for a motorcycle.

It is contemplated that the vehicle 1 may be operated for road use or it may be operated by skilled professionals on a racing track. During operation, it is anticipated that the driver will likely lean to one side of the vehicle 1 to shift the driver's weight while turning the vehicle or driving through a curve. The arrangement of the seat assembly 90 and the foot rests permit the driver to shift his or her weight during the operation of the vehicle 1 to improve maneuverability and control. In the event that the driver leans to the left side of the vehicle 1 during operation of the vehicle 1, the driver's position on the seat assembly 90 is altered. The driver applies pressure with the left leg to the left knee pad 82. The driver's right foot engages the right toe hold 104. The provision of the dip 91 and the tapered side surfaces 93 permit the driver to maintain his grip of the seat with his or her legs. As the driver leans to the right, the driver's left foot engages the left toe hold 103. The provision of the toe holds 103 and 104 permit the driver's feet to remain in engagement with the vehicle 1 during turns or while leaning on the vehicle.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. A three-wheeled straddle type vehicle for operation by a rider, wherein the weight of the rider leans against the vehicle during operation, the vehicle comprising:
a frame having a front portion and a rear portion;
a pair of front wheels rotatably connected to the front portion of the frame;
a single rear wheel rotatably connected to the rear portion of the frame;
an engine connected to the frame, wherein the engine provides power to drive at least one of the single rear wheel and the pair of front wheels;
a straddle type seat connected to the frame, wherein the seat is positioned on the frame such that the rider of the vehicle straddles the seat when operating the vehicle;
a pair of foot rests connected to the frame, a first foot rest being located on one side of the seat such that a portion of one foot of the rider rests on the first foot rest during operation of the vehicle, and a second foot rest being located on an opposite side of the seat such that a portion of the other foot of the rider rests on the second foot rest during operation of the vehicle;
a first toe hold connected to the frame located on one side of the seat, wherein the first toe hold is spaced from the first foot rest, suitable so that the foot of the rider engages the first toe hold when the rider leans to the other side of the vehicle; and
a second toe hold connected to the frame located on the opposite side of the seat, wherein the second toe hold is spaced from the second foot rest, suitable so that the other foot of the rider engages the second toe hold when the rider leans to the opposite side of the vehicle.

2. The three-wheeled straddle type vehicle according to claim 1, wherein each of the first toe hold and the second toe, hold includes a peg, wherein a top portion of one foot engages the peg of the first toe hold suitable for the rider to lean towards a side opposite of the vehicle opposite the first toe hold, wherein a top portion of the other foot engages the peg of the second toe hold when the rider leans toward a side of the vehicle opposite the second toe hold.

3. The three-wheeled straddle type vehicle according to claim 1, wherein each of the first toe hold and the second toe hold includes a foot guard which partially surrounds the toe of the rider, wherein a top portion of one foot engages the foot guard of the first toe hold when the rider leans towards a side opposite of the vehicle opposite the first toe hold, wherein a top portion of the other foot engages the foot guard of the second toe hold when the rider leans toward a side of the vehicle opposite the second toe hold.

4. The three-wheeled straddle type vehicle according to claim 1, wherein the straddle type seat includes a top portion, a front portion, a rear portion and a pair of opposing side portions, wherein the straddle type seat further includes a recessed portion located in at least one of the top portion and the side portions.

5. The three-wheeled straddle type vehicle according to claim 4, wherein the recessed portion is sized to receive a portion of a leg of the rider when the rider leans to one side of the vehicle.

6. The three-wheeled straddle type vehicle according to claim 5, wherein the recessed portion is located in the top portion of the seat.

7. The three-wheeled straddle type vehicle according to claim 6, wherein the recessed portion is located in each of the side portions.

8. The three-wheeled straddle type vehicle according to claim 5, wherein the recessed portion is located in each of the side portions.

9. The three-wheeled straddle type vehicle according to claim 4, wherein the recessed portion is substantially aligned with the pair of rests.

10. The three-wheeled straddle type vehicle according to claim 1, wherein the frame has a tubular construction.

11. The three-wheeled straddle type vehicle according to claim 1, wherein each of the wheels includes a tire suitable for road use.

12. The three-wheeled straddle type vehicle according to claim 1, wherein the straddle type seat has a side profile and a top profile, wherein the side profile includes a central portion having a first height, a front end portion having a second height and a rear end portion having a third height, wherein the first height is less than each of the second height and the third height, wherein the central portion is substantially aligned with the pair of foot rests.

13. The three-wheeled straddle type vehicle according to claim 12, wherein the top profile includes a central straddle portion having a first width, a front portion having a second width and a rear portion having a third width, wherein the first width is less than each of the second width and the third width, wherein the central portion is substantially aligned with the pair of foot pegs, the first toe hold and the second toe hold.

14. The three-wheeled straddle type vehicle according to claim 1, further comprising a pair of leaning pads secured to opposing sides of the vehicle, wherein the pair of leaning pads are positioned such that the area around one knee of the rider engages one of the leaning pads when the rider leans to the other side of the vehicle and the area around an opposite knee of the rider engages the other of the leaning pads when the rider leans to the opposite side of the vehicle.

15. The three-wheeled straddle type vehicle according to claim 14, wherein at least a portion of the frame is exposed adjacent the sides of the vehicle, wherein the pair of leaning pads are positioned adjacent the exposed portion of the frame.

16. The three-wheeled straddle type vehicle according to claim 15, wherein each of the pair of leaning pads provides a smooth transition to the exposed portion of the frame.

17. The three-wheeled straddle type vehicle according to claim 1, further comprising:
a steering assembly for steering the vehicle, wherein the steering assembly includes a handlebar assembly for gripping by the rider, wherein the handlebar assembly includes a left hand grip and right hand grip; and
at least one hand operated control assembly for controlling the operation of the vehicle, wherein the at least one hand operated control assembly is associated with at least one of the left hand grip and the right hand grip.

18. The three-wheeled straddle type vehicle according to claim 17, wherein the at least one hand operated control assembly includes a throttle assembly, wherein the throttle assembly is operatively associated with the right hand grip.

19. The three-wheeled straddle type vehicle according to claim 18, wherein the throttle assembly is a throttle lever located adjacent the right hand grip.

20. The three-wheeled straddle type vehicle according to claim 18, wherein the throttle assembly is rotatable throttle incorporated into the right hand grip.

21. The three-wheeled straddle type vehicle according to claim 17, wherein the at least one hand operated control assembly includes a braking control lever, wherein the braking control lever is associated with the left hand grip.

22. The three-wheeled straddle type vehicle according to claim 1, wherein the pair of foot rests comprise a pair of pegs connected to the frame.

23. The three-wheeled straddle type vehicle according to claim 1, wherein the pair of foot rests comprise a pair of foot boards connected to the frame.

24. The three-wheeled straddle type vehicle according to claim 1, wherein the single rear wheel includes a pair of tires.

25. A three-wheeled straddle type vehicle for operation by a rider, wherein the weight of the rider leans against the vehicle during operation, the vehicle comprising:
a frame having a front portion and a rear portion;
a pair of front wheels rotatably connected to the front portion of the frame;
a single rear wheel rotatably connected to the rear portion of the frame;
an internal combustion engine connected to the frame, wherein the internal combustion engine provides power to drive at least one of the single rear wheel and the pair of front wheels;
a pair of foot rests connected to the frame, wherein a first foot rest being located on one side of the vehicle such that a portion of one foot of the rider rests on the first foot rest during operation of the vehicle, and a second foot rest being located on an opposite side of the vehicle such that a portion of another foot of the rider rests on the second foot rest during operation of the vehicle; and
a straddle type seat connected to the frame, wherein the seat is positioned on the frame such that the rider of the vehicle straddles the seat when operating the vehicle, wherein the straddle type seat has a side profile and a top profile, wherein the side profile includes a central portion having a first height, a front end portion having a second height and a rear end portion having a third height, wherein the first height is less than each of the second height and the third height, wherein the central portion is substantially aligned with the pair of foot pegs.

26. The three-wheeled straddle type vehicle according to claim 25, further comprising:
a first toe hold connected to the frame located on one side of the vehicle, wherein the first toe hold is spaced from the first foot rest;
a second toe hold connected to the frame located on the opposite side of the vehicle, wherein the second toe hold is spaced from the second foot rest, and
wherein the top profile includes a central straddle portion having a first width, a front portion having a second width and a rear portion having a third width, wherein the first width is less than each of the second width and the third width, wherein the central portion is substantially aligned with the pair of foot rests, the first toe hold and the second toe hold.

27. The three-wheeled straddle type vehicle according to claim 25, further comprising a pair of leaning pads secured to opposing sides of the vehicle, wherein the pair of leaning pads are positioned such that the area adjacent one knee of the rider engages one of the leaning pads when the rider leans to the other side of the vehicle and the area adjacent an opposite knee of the rider engages the other of the leaning pads when the rider leans to the opposite side of the vehicle.

28. The three-wheeled straddle type vehicle according to claim 27, wherein at least a portion of the frame is exposed adjacent the sides of the vehicle, wherein the pair of leaning pads are positioned adjacent the exposed portion of the frame.

29. The three-wheeled straddle type vehicle according to claim 28, wherein each of the pair of leaning pads provides a smooth transition to the exposed portion of the frame.

30. The three-wheeled straddle type vehicle according to claim 25, wherein the pair of foot rests comprise a pair of pegs connected to the frame.

31. The three-wheeled straddle type vehicle according to claim 25, wherein the pair of foot rests comprise a pair of foot boards connected to the frame.

32. The three-wheeled straddle type vehicle according to claim 25, wherein the single rear wheel includes a pair of tires.

33. A straddle type three wheel vehicle for at least two riders, comprising:
a frame having a front portion and a rear portion, wherein the frame has a head pipeless construction;
a pair of front wheels rotatably connected to the front portion of the frame;
a single rear wheel rotatably connected to the rear portion of the frame, wherein each of the pair of front wheels and the single rear wheel includes a tire capable of road use;
a straddle type vehicle seat connected to the frame, wherein the seat is sized to accommodate at least two riders;
an engine connected to the frame, wherein the engine provides power to drive at least one of the single rear wheel and the pair of front wheels;
a vehicle suspension system operatively connected to at least one of the pair of front wheels and the single rear wheel;
a first pair of foot rests connected to the frame, wherein a first foot rest being located on one side of the vehicle such that a portion of one foot of the rider rests on the first foot rest during operation of the vehicle, and a second foot rest being located on an opposite side of the vehicle such that a portion of another foot of the rider rests on the second foot rest during operation of the vehicle; and
a straddle type seat connected to the frame, wherein the seat is positioned on the frame such that the rider of the vehicle straddles the seat when operating the vehicle, wherein the straddle type seat has a side profile and a top profile, wherein the side profile includes a central portion having a first height, a front end portion having a second height and a rear end portion having a third height, wherein the first height is less than each of the second height and the third height, wherein the central portion is substantially aligned with the pair of foot rests.

34. The three-wheeled straddle type vehicle according to claim 33, further comprising:
a first toe hold connected to the frame located on one side of the vehicle, wherein the first toe hold is spaced from the first foot rest;
a second toe hold connected to the frame located on the opposite side of the vehicle, wherein the second toe hold is spaced from the second foot rest, and
wherein the top profile includes a central straddle portion having a first width, a front portion having a second width and a rear portion having a third width, wherein the first width is less than each of the second width and the third width, wherein the central portion is substantially aligned with the pair of foot pegs, the first toe hold and the second toe hold.

35. The three-wheeled straddle type vehicle according to claim 33, further comprising a pair of leaning pads secured to opposing sides of the vehicle, wherein the pair of leaning pads are positioned such that the area adjacent one knee of the rider engages one of the leaning pads when the rider leans to the other side of the vehicle and the area adjacent an opposite knee of the rider engages the other of the leaning pads when the rider leans to the opposite side of the vehicle.

36. The three-wheeled straddle type vehicle according to claim 35, wherein at least a portion of the frame is exposed adjacent the sides of the vehicle, wherein the pair of leaning pads are positioned adjacent the exposed portion of the frame.

37. The three-wheeled straddle type vehicle according to claim 36, wherein each of the pair of leaning pads provides a smooth transition to the exposed portion of the frame.

38. The three-wheeled straddle type vehicle according to claim 33, wherein the pair of foot rests comprise a pair of pegs connected to the frame.

39. The three-wheeled straddle type vehicle according to claim 33, wherein the pair of foot rests comprise a pair of foot boards connected to the frame.

40. The three-wheeled straddle type vehicle according to claim 33, wherein the single rear wheel includes a pair of tires.

41. The three-wheeled straddle type vehicle according to claim 33, further comprising:
a second pair of foot rests connected to the frame a position rearwardly of the first pair of foot rests such that a portion of one foot of another rider rests on one of the second pair of foot rests and a portion of another foot of the other rider rests on another of the second pair of foot rests.

42. A three-wheeled straddle type vehicle for operation by a rider, wherein the weight of the rider leans against the vehicle during operation, the vehicle comprising:
a frame having a front portion and a rear portion;
a pair of front wheels rotatably connected to the front portion of the frame;
a single rear wheel rotatably connected to the rear portion of the frame;
an engine connected to the frame, wherein the engine provides power to drive at least one of the single rear wheel and the pair of front wheels;
a straddle type seat connected to the frame, wherein the seat is positioned on the frame such that the rider of the vehicle straddles the seat when operating the vehicle;
a first toe hold connected to the frame located on one side of the seat so that the foot of the rider engages the first toe hold when the rider leans to the other side of the vehicle;
a second toe hold connected to the frame located on the opposite side of the seat so that the other foot of the rider engages the second toe hold when the rider leans to the opposite side of the vehicle; and
a pair of leaning pads secured to opposing sides of the vehicle, wherein the pair of leaning pads are positioned such that the area around one knee of the rider engages one of the leaning pads when the rider leans to the other side of the vehicle and the area around an opposite knee of the rider engages the other of the leaning pads when the rider leans to the opposite side of the vehicle.
